(19) United States
(12) Patent Application Publication
(10) Pub. No.: US 2019/0318047 A1
(43) Pub. Date: Oct. 17, 2019

(54) BUILDING THERMAL MODEL GENERATION APPARATUS, BUILDING THERMAL MODEL GENERATION METHOD, AND BUILDING THERMAL MODEL GENERATION PROGRAM

(71) Applicant: NEC Corporation, Minato-ku, Tokyo (JP)

(72) Inventor: Takuma KOGO, Tokyo (JP)

(73) Assignee: NEC Corporation, Minato-ku, Tokyo (JP)

(21) Appl. No.: 16/308,856

(22) PCT Filed: May 2, 2017
(86) PCT No.: PCT/JP2017/017227

§ 371 Date: Dec. 11, 2018

(30) Foreign Application Priority Data
Jun. 15, 2016 (JP) 2016-118512

(51) Int. Cl. G06F 17/50; F24F 11/63; G01W 1/10

(52) U.S. Cl. CPC G06F 17/5004; G06F 2217/80; G01W 1/10; F24F 11/63

(57) ABSTRACT

A building thermal model generation apparatus 10 is provided with an estimation unit 11 that estimates, by using data for estimation, a building thermal model parameter which satisfies a prescribed condition of a building thermal model indicative of the temperature of a building, the building thermal model including an internal thermal load model indicative of a time change of heat generated inside the building.

### TECHNICAL FIELD

The present invention relates to a building thermal model generation apparatus, a building thermal model generation method, and a building thermal model generation program, and particularly to a building thermal model generation apparatus, a building thermal model generation method, and a building thermal model generation program for use in generating an efficient operation plan of an air conditioner in a building such as an office building.

### BACKGROUND ART

Since the cost of an air conditioning system occupies the most part of the energy cost relating to a building, there is an increasing demand for an energy cost reduction by saving energy of the air conditioning system. To satisfy this demand, numerous methods of controlling an air conditioning system have been proposed.

For example, Patent Literature (PTL) 1 and Non Patent Literature (NPL) 1 each describe a model predictive control method for computing the operation plan of an air conditioning system which increases an energy efficiency on the basis of a thermal model relating to a building (hereinafter, also referred to as “building thermal model”). The building thermal model is a model by which the temperature of the constituents of a building or the temperature inside the building can be predicted.

Specifically, in the model predictive control methods described in PTL 1 and NPL 1, a thermal model relating to a building to be controlled is estimated on the basis of measurement data of an outside air temperature, an amount of solar radiation, an indoor temperature, an air conditioner supply air temperature, a supply air volume, and the like.

Subsequently, the model predictive control method is intended to solve a problem of computing an operation plan for an air conditioning system for achieving the minimum energy cost, as an optimization problem, by using the estimated building thermal model. The model predictive control method enables the computation of the operation plan for achieving the minimum energy cost by solving the optimization problem.

In addition to the methods described in PTL 1 and NPL 1, there have been proposed various building thermal model generation methods and operation plan computation methods. Furthermore, also regarding a building thermal model itself, various models have been proposed.

The building thermal model and each method to be used affect the performance of the air conditioning system such as an operating efficiency, which is measured by the amount of reduction of energy costs or the like. The refinement of the building thermal model and each method is a major research theme in this field.

### CITATION LIST

### Patent Literature

PTL 1: Japanese Patent No. 5572799

### Non Patent Literature

NPL 1: Yudong Ma et al., “Predictive Control for Energy Efficient Buildings with Thermal Storage,” IEEE Control Systems Magazine, February 2012.

### SUMMARY OF INVENTION

### Technical Problem

In the model predictive control method described in NPL 1, the prediction is refined correspondingly by the adoption of a building thermal model based on a heat conduction equation following physical laws. In the aforementioned model predictive control method, however, internal thermal loads such as a thermal load generated by human body heat, a thermal load generated by heated electrical equipment, a thermal load generated by draft, and the like are not sufficiently handled.

PTL 1 describes a method of using measured values obtained from measuring devices and a method of using estimated values computed on the basis of prior information on usages of the building structure and constituents or the like, as a method of acquiring numerical information on the internal thermal loads. Both methods, however, have problems.

The method of using measured values obtained from measuring devices has a problem of a lack of practicality due to an increase in equipment cost since a large number of measuring devices need to be installed in a building. Even if all measuring devices were installed, for example, a manager is required to verify the building by a numerical analysis or the like after acquiring considerable technical knowledge in order to quantify the behavior of the main internal thermal load of the building with high accuracy. In other words, the manager is required to spend enormous effort (cost) for the execution of the numerical analysis for verification.

In the method of using the estimated values computed on the basis of the prior information on the usages of the building structure and constituents or the like, there are used estimated values related to internal thermal loads computed on the basis of respective representative values of the number of persons in the building, the total power consumption value of electrical equipment, and the like. The method, however, has a problem that an error easily occurs between computed estimated values and true numerical information on the internal thermal loads since the computation method is simplified.

Furthermore, also in this method, the computation of accurate estimated values requires a verification work of the usages of the building structure and constituents by a numerical analysis or the like in addition to a large amount of knowledge of the usages of the building structure and constituents. In other words, the manager is required to spend enormous cost to perform the numerical analysis for the verification similarly to the method of using measured values obtained from measuring devices.

As described above, in the case of acquiring numerical information on internal thermal loads by using the method described in PTL 1, the manager is required to spend high cost to acquire numerical information since the method requires the cost for the installation of measuring devices or the cost for the execution of the numerical analysis.

Furthermore, in the case of adopting the method of using the estimated values computed on the basis of prior information, the accuracy of an identified building thermal model is likely to be reduced by an error included in any of the estimated values. Moreover, the estimated value including an error is used as a predicted value also in computing the operation plan of an air conditioning system using the model predictive control method, by which an operation plan for implementing high energy efficiency may not be achieved. Unless the operation plan for implementing high energy efficiency is achieved, an energy saving effect decreases.

Therefore, it is an object of the present invention to provide a building thermal model generation apparatus, a building thermal model generation method, and a building thermal model generation program capable of implementing a control with a model prediction for an air conditioning system in consideration of internal thermal loads in a building at low cost and with high accuracy to solve the above problems.

### Solution to Problem

According to an aspect of the present invention, there is provided a building thermal model generation apparatus including an estimation unit which estimates, by using data for estimation, a building thermal model parameter which satisfies a prescribed condition of a building thermal model indicative of the temperature of a building, the building thermal model including an internal thermal load model indicative of a time change of heat generated inside the building.

According to another aspect of the present invention, there is provided a building thermal model generation method including a step of estimating, by using data for estimation, a building thermal model parameter which satisfies a prescribed condition of a building thermal model indicative of the temperature of a building, the building thermal model including an internal thermal load model indicative of a time change of heat generated inside the building.

According to still another aspect of the present invention, there is provided a building thermal model generation program causing a computer to perform an estimation process of estimating, by using data for estimation, a building thermal model parameter which satisfies a prescribed condition of a building thermal model indicative of the temperature of a building, the building thermal model including an internal thermal load model indicative of a time change of heat generated inside the building.

### Advantageous Effects of Invention

The present invention enables the control with a model prediction for an air conditioning system in consideration of internal thermal loads in a building at low cost and with high accuracy.

### BRIEF DESCRIPTION OF DRAWINGS

FIG. 1 is a block diagram showing a configuration example of a first example embodiment of a building thermal model generation apparatus 100 according to the present invention.

FIG. 2 is an explanatory diagram showing explanatory variables of a building thermal model of the first example embodiment.

FIG. 3 is a block diagram showing a configuration example of the first example embodiment of an air conditioning system operation planning device 200.

FIG. 4 is a flowchart showing an operation of a computation process performed by the building thermal model generation apparatus 100 according to the first example embodiment.

FIG. 5 is an explanatory diagram showing examples of an estimation result of a time change of an indoor temperature change caused by internal thermal loads.

FIG. 6 is an explanatory diagram showing other examples of an estimation result of a time change of an indoor temperature change caused by internal thermal loads.

FIG. 7 is a block diagram showing an outline of the building thermal model generation apparatus according to the present invention.

### DESCRIPTION OF EMBODIMENT

### Example Embodiment 1

[Description of Configuration]

The following describes an example embodiment of the present invention, particularly a building thermal model generation apparatus according to the example embodiment of the present invention with reference to appended drawings. In each drawing, the same elements are denoted by the same reference numerals. Additionally, the description of the same elements will be appropriately omitted for the sake of clarity of description.

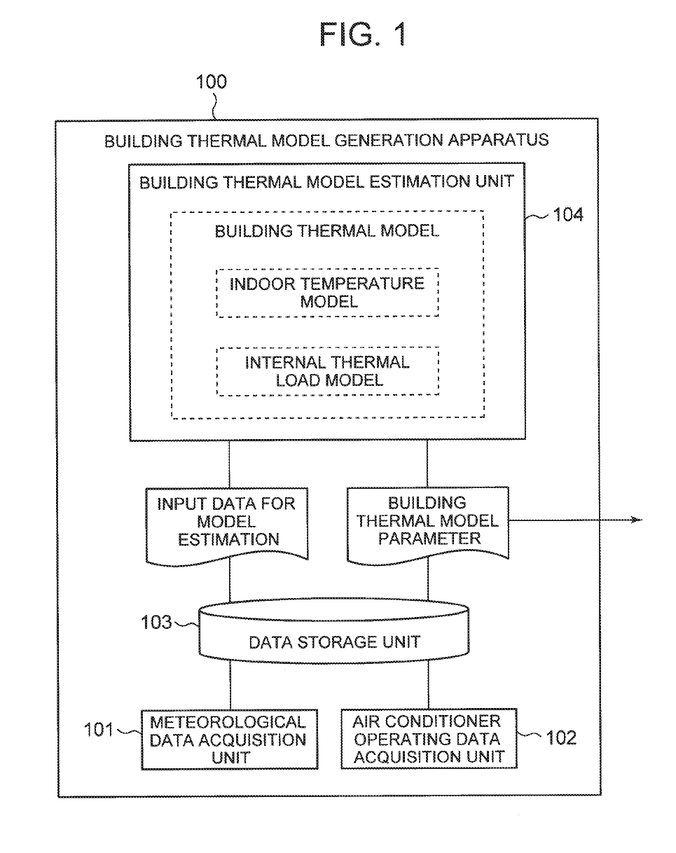

First, the configuration of the building thermal model generation apparatus according to the example embodiment of the present invention will be described. FIG. 1 is a block diagram showing a configuration example of a first example embodiment of a building thermal model generation apparatus 100 according to the present invention. As showed in FIG. 1, the building thermal model generation apparatus 100 of this example embodiment includes a meteorological data acquisition unit 101, an air conditioner operating data acquisition unit 102, a data storage unit 103, and a building thermal model estimation unit 104.

The meteorological data acquisition unit 101 has a function of acquiring meteorological data, which is data indicating the weather conditions around a building to be processed by the building thermal model generation apparatus 100. The meteorological data acquisition unit 101 acquires at least data of outside air temperature and data of the amount of solar radiation as meteorological data. The meteorological data acquisition unit 101 inputs the acquired meteorological data into the data storage unit 103.

The air conditioner operating data acquisition unit 102 has a function of acquiring air conditioner operating data, which is data indicating the operation conditions of an air conditioner installed inside the building to be processed by the building thermal model generation apparatus 100.

The air conditioner operating data acquisition unit 102 acquires at least data of indoor temperature, data of air conditioner supply air temperature, and data of an air conditioner supply air volume as air conditioner operating data. The air conditioner operating data acquisition unit 102 inputs the acquired air conditioner operating data into the data storage unit 103.

In the case of not being able to acquire the data of indoor temperature, the air conditioner operating data acquisition unit 102 may use data of air conditioner supply air temperature instead. Similarly, the air conditioner operating data acquisition unit 102 may use data of an air conditioner indoor temperature setting value in the case of not being able to acquire the data of air conditioner supply air temperature or may use data of an air conditioner supply air volume setting value in the case of not being able to acquire the data of an air conditioner supply air volume, instead.

Moreover, in the case of not being able to acquire respective data, the air conditioner operating data acquisition unit 102 may use an estimated value of an indoor temperature, an estimated value of air conditioner supply air temperature, and an estimated value of an air conditioner supply air volume computed on the basis of control characteristics or the like of the air conditioner, instead respectively.

The building thermal model generation apparatus 100 is able to transmit and receive data to and from an external system via a communication network or the like. For example, the building thermal model generation apparatus 100 may include a transmitting and receiving unit (not showed) which transmits and receives data to and from the external system.

If the building thermal model generation apparatus 100 is provided with the transmitting and receiving unit, the meteorological data acquisition unit 101 is able to acquire meteorological data from an external system via the transmitting and receiving unit. Similarly, the air conditioner operating data acquisition unit 102 is able to acquire air conditioner operating data from the external system via the transmitting and receiving unit.

Incidentally, the meteorological data acquisition unit 101 and the air conditioner operating data acquisition unit 102 may receive data directly from the external system without using the transmitting and receiving unit.

The data storage unit 103 has a function of storing the meteorological data input from the meteorological data acquisition unit 101 and the air conditioner operating data input from the air conditioner operating data acquisition unit 102.

The building thermal model estimation unit 104 has a function of estimating a building thermal model parameter, which is a parameter for a building thermal model. The building thermal model estimation unit 104 acquires input data for model estimation stored in the data storage unit 103 from the data storage unit 103. Subsequently, the building thermal model estimation unit 104 estimates a building thermal model parameter by using the acquired input data for model estimation.

The input data for model estimation of this example embodiment, which is time-series data over an estimated period, includes at least an outside air temperature, an amount of solar radiation, an indoor temperature, an air conditioner supply air temperature, and an air conditioner supply air volume, or data equivalent thereto. The estimated period is set in a prescribed method such as a user operation.

Moreover, the input data for model estimation may be pre-processed measurement data. The pre-processing is a removal of noise or outliers, transformation of a sampling period by decimation (skipping), or the like. The building thermal model estimation unit 104 may perform the pre-processing for the meteorological data and the air conditioner operating data to use the pre-processed data as the input data for model estimation.

The building thermal model estimation unit 104 inputs the estimated building thermal model parameter into the data storage unit 103. The data storage unit 103 stores the building thermal model parameter input from the building thermal model estimation unit 104.

The building thermal model of this example embodiment includes an indoor temperature model and an internal thermal load model. The indoor temperature model is a mathematical model indicative of a time change of the indoor temperature based on a heat conduction equation.

The internal thermal load model is a mathematical model indicative of a time change of the total sum of thermal loads generated inside the building such as a thermal load generated by human body heat, a thermal load generated by heated electrical equipment, a thermal load generated by draft, and the like. Incidentally, the building thermal model of this example embodiment may be composed of an internal thermal load model and a model other than the indoor temperature model, which is a mathematical model based on a heat conduction equation.

Furthermore, the building thermal model parameter of this example embodiment includes a parameter of the indoor temperature model and a parameter of the internal thermal load model.

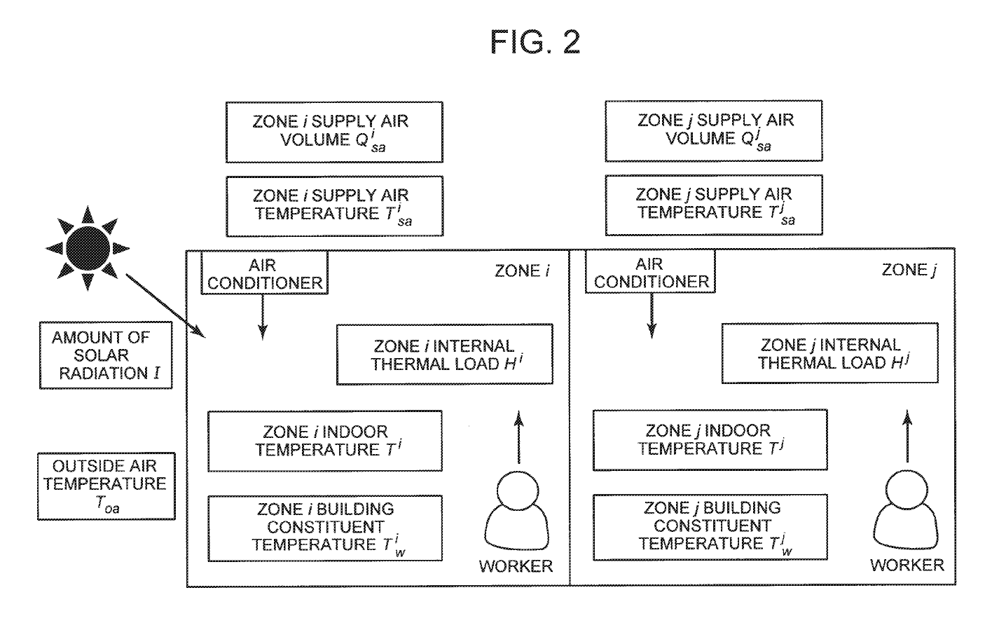

The building thermal model of this example embodiment will be specifically described with reference to FIG. 2. FIG. 2 is an explanatory diagram showing explanatory variables of a building thermal model of the first example embodiment.

The building thermal model estimation unit 104 of this example embodiment handles spaces, to which the controlled indoor temperature is common inside the building to be processed, as one unit. Hereinafter, the unit in which the controlled indoor temperature is common is referred to as a zone. FIG. 2 shows two zones extracted from a large number of zones present inside the building. The left rectangle in which a worker is located showed in FIG. 2 represents a zone i and the right rectangle in which a worker is located showed in FIG. 2 represents a zone j.

Incidentally, the zones are spaces delimited according to physically partitioned units of constituents of the building such as, for example, floors, rooms, or the like. In addition, the zones may be logically delimited spaces in addition to the spaces physically delimited in units of the constituents.

As showed in FIG. 2, the building thermal model of the zone i has explanatory variables such as an amount of solar radiation I, an outside air temperature Tₒₐ, a zone i supply air volume Q^{j}ₛₐ, a zone i supply air temperature Tⁱₛₐ, a zone i internal thermal load Hⁱ, a zone i indoor temperature Tⁱ, and a zone i building constituent temperature Tⁱ_{w}. Moreover, an arrow showed in FIG. 2 indicates an inflow of heat from a heat source.

As showed in FIG. 2, the amount of solar radiation I, the outside air temperature Tₒₐ, the zone i supply air volume Qⁱₛₐ, and the zone i supply air temperature Tⁱₛₐ are explanatory variables representing the peripheral situation of the zone i. Furthermore, as showed in FIG. 2, the zone i internal thermal load Hⁱ, the zone i indoor temperature Tⁱ, and the zone i building constituent temperature Tⁱ_{w} are explanatory variables representing the internal situation of the zone i.

Similarly, as showed in FIG. 2, the building thermal model of the zone j has explanatory variables such as an amount of solar radiation I, an outside air temperature Tₒₐ, a zone j supply air volume Q^{j}ₛₐ, a zone j supply air temperature T^{j}ₛₐ, a zone j internal thermal load H^{j}, a zone j indoor temperature T^{j}, and a zone j building constituent temperature T^{j}_{w}. The average temperature of the building constituents is an average temperature of walls, windows, pillars, desks, chairs, partitions, and the like.

The building thermal model of the zone j having the explanatory variables showed in FIG. 2 is expressed, for example, by the following equations (1) to (3).

$$\begin{matrix} [ Math . 1 ] & \\ \dot{{T}^{j}} = {c}_{jw}^{j} ( {T}_{w}^{j} - {T}^{j} ) + {\sum }_{∀ i ∈ Z} {c}_{sa}^{i , j} {Q}_{sa}^{i} ( {T}_{sa}^{i} - {T}^{j} ) + {\sum }_{∀ i ∈ Z} {c}_{z}^{i , j} ( {T}^{i} - {T}^{j} ) + {c}_{oa}^{j} ( {T}_{oa} - {T}^{j} ) {c}_{sr}^{j} I + {H}^{j} , ∀ j ∈ Z & Equation ( 1 )\end{matrix}$$

[Math. 2]

\dot{T}_{w}^{j}=c_{tw}^{j}(T^{j}−T_{w}^{j}), ∀j ∈Z Equation 2)

[Math. 3]

H^{j}=f^{j}(t; cₕ^{j,1}, . . . , cₕ^{j,N}^{ₕ}ⁱ), ∀j ∈Z Equation (3)

Incidentally, Z in the equations (1) to (3) represents a set of zone identifiers. Moreover, i and j represent zone identifiers, respectively. The indoor temperature model is expressed by the equation (1) with the term of the zone j internal thermal load H^{j} omitted and the equation (2).

The dot (.) over a variable in each of the equations (1) and (2) denotes a time differential. In other words, the variable with the dot appended represents a time rate of change of the variable. Specifically, the equation (1) is a time derivative of the indoor temperature in the zone j and therefore represents a time rate of change of the indoor temperature in the zone j. Moreover, the equation (2) is a time derivative of the building constituent temperature in zone j and therefore represents a time rate of change of the building constituent temperature in zone j.

Moreover, although the zone j internal thermal load H^{j} has been described as an explanatory variable for convenience in the description of FIG. 2, the zone j internal thermal load H^{j} is a mathematical model defined as an internal thermal load model. Specifically, the zone j internal thermal load H^{j} is expressed by the equation (3).

Hereinafter, the indoor temperature model will be specifically described. In the equations (1) and (2), c^{j}_{fw}, c^{i,j}ₛₐ, c^{i,j}_{z}, c^{j}ₒₐ, c^{j}ₛᵣ, c^{j}_{tw}, and ∀i,j∈Z are coefficients. The respective coefficients are parameters of the indoor temperature model constituting the building thermal model parameter.

The coefficient c^{j}_{fw} represents the degree of influence of a relationship between the indoor temperature in the zone j and the building constituent temperature in the zone j on an indoor temperature change. The coefficient c^{i,j}ₛₐ represents the degree of influence of a relationship between the indoor temperature in the zone j, the supply air temperature in the zone i, and the supply air volume in the zone i on an indoor temperature change.

The coefficient c^{i,j}_{z} represents the degree of influence of a relationship between the indoor temperature in the zone j and the indoor temperature in the zone i on an indoor temperature change. The coefficient c^{j}ₒₐ represents the degree of influence of a relationship between the indoor temperature in the zone j and the outside air temperature on an indoor temperature change.

The coefficient c^{j}ₛᵣ represents the degree of influence of the amount of solar radiation on an indoor temperature change. The coefficient c^{j}_{tw} represents the degree of influence of the relationship between the building constituent temperature in the zone j and the indoor temperature in the zone j on a building constituent temperature change.

Subsequently, the internal thermal load model will be specifically described. As described in the equation (3), the zone j internal thermal load H^{j} is represented by a function f^{j} of time t. Moreover, as described in the equation (3), the function f^{j} has coefficients c^{j,1}ₕ, . . . , c^{j,Njh}ₕ. Specifically, the function f^{j} has N^{j}ₕ number of coefficients. The coefficients c^{j,1}ₕ, . . . , c^{j,Njh}ₕ, and ∀j∈Z are parameters of the internal thermal load model constituting the building thermal model parameter. The correct notation of the parameter “c^{j,Njh}ₕ” is as described below.

cₕ^{j,N}^{ₕ}^{j} [Math. 4]

With the above configuration, the building thermal model estimation unit 104 is able to compute the parameters of the indoor temperature model and the parameters of the internal thermal load model constituting the building thermal model parameter simultaneously.

An air conditioning system operation planning device 200, which is an external system of the building thermal model generation apparatus 100, uses the building thermal model parameter estimated by the building thermal model estimation unit 104. The estimated building thermal model parameter is transmitted to the air conditioning system operation planning device 200 via the transmitting and receiving unit (not showed) or the like.

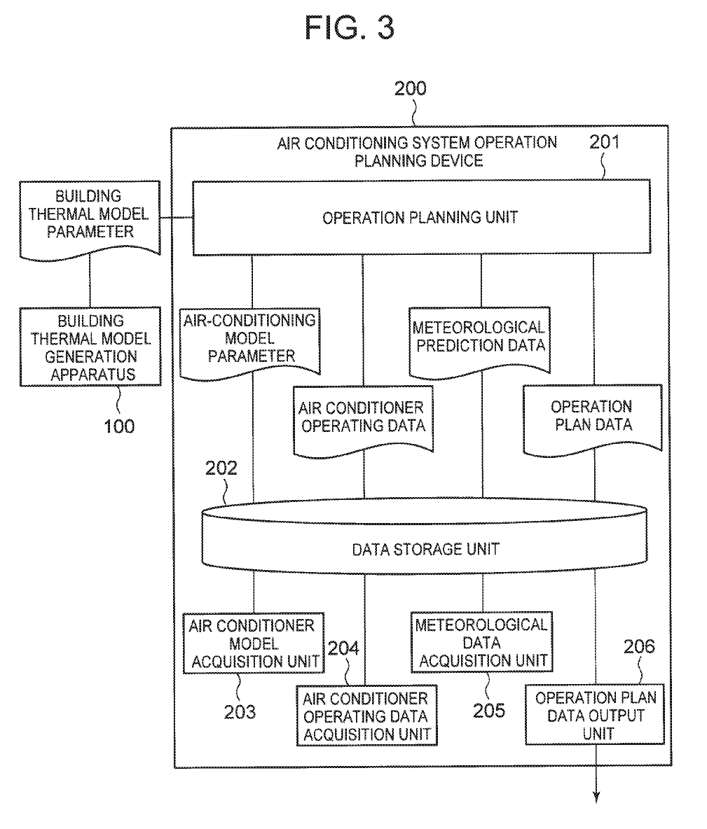

FIG. 3 is a block diagram showing a configuration example of the first example embodiment of the air conditioning system operation planning device 200. As showed in FIG. 3, the air conditioning system operation planning device 200 of this example embodiment includes an operation planning unit 201, a data storage unit 202, an air conditioner model acquisition unit 203, an air conditioner operating data acquisition unit 204, a meteorological data acquisition unit 205, and an operation plan data output unit 206.

The operation planning unit 201 has a function of computing the operation plan of an air conditioner installed inside the building to be processed by the air conditioning system operation planning device 200. Furthermore, the data storage unit 202 has a function of storing respective data acquired by the air conditioner model acquisition unit 203, the air conditioner operating data acquisition unit 204, and the meteorological data acquisition unit 205.

The air conditioner model acquisition unit 203 has a function of acquiring an air conditioning model parameter. Furthermore, the air conditioner operating data acquisition unit 204 has a function of acquiring air conditioner operating data. Moreover, the meteorological data acquisition unit 205 has a function of acquiring meteorological prediction data.

The operation planning unit 201 computes the operation plan of the air conditioner on the basis of the building thermal model parameter acquired from the building thermal model generation apparatus 100, and the air conditioning model parameter, the air conditioner operating data, and the meteorological prediction data acquired from the data storage unit 202.

The operation planning unit 201 inputs the operation plan data, which is data representing the computed operation plan of the air conditioner, into the data storage unit 202. The data storage unit 202 stores the input operation plan data.

The operation plan data output unit 206 has a function of transmitting the operation plan data acquired from the data storage unit 202 to an external system.

[Description of Operation]

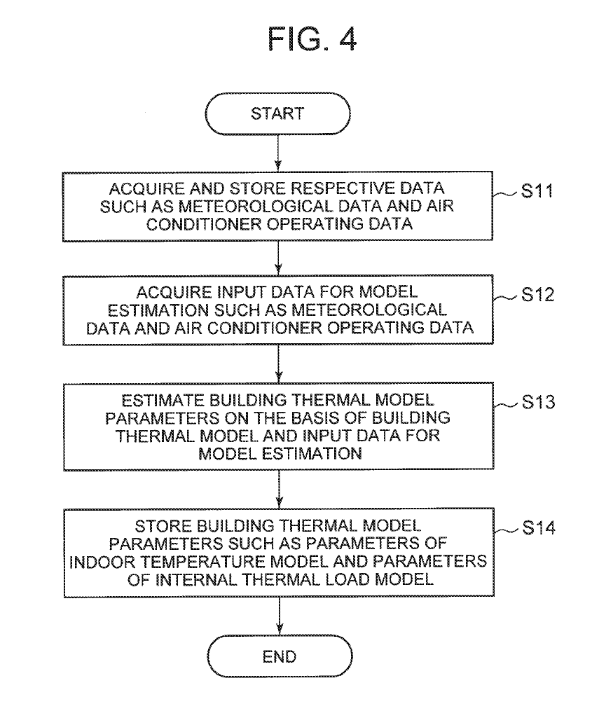

Hereinafter, the operation of the computation process performed by the building thermal model generation apparatus 100 of this example embodiment will be described with reference to FIG. 4. FIG. 4 is a flowchart showing the operation of the computation process performed by the building thermal model generation apparatus 100 according to the first example embodiment.

The meteorological data acquisition unit 101 acquires the meteorological data from an external system. Furthermore, the air conditioner operating data acquisition unit 102 acquires air conditioner operating data from an external system. The meteorological data acquisition unit 101 and the air conditioner operating data acquisition unit 102 receive the respective data via, for example, a communication network.

Subsequently, the meteorological data acquisition unit 101 and the air conditioner operating data acquisition unit 102 input the respective acquired data into the data storage unit 103. The data storage unit 103 stores the input data (step S11).

Subsequently, the building thermal model estimation unit 104 acquires the meteorological data and the air conditioner operating data as input data for model estimation by the amount corresponding to an estimated period (step S12). Specifically, the building thermal model estimation unit 104 acquires the input data for model estimation by acquiring the stored meteorological data and air conditioner operating data from the data storage unit 103 by the amount corresponding to the estimated period.

Incidentally, the building thermal model estimation unit 104 may acquire pre-processed time-series data as input data for model estimation by performing pre-processing such as a removal of noise or outliers, transformation of a sampling period by decimation, or the like for the acquired meteorological data and air conditioner operating data.

Subsequently, the building thermal model estimation unit 104 estimates building thermal model parameters c^{j}_{fw}, c^{i,j}ₛₐ, c^{i,j}_{z}, c^{j}ₒₐ, c^{j}ₛᵣ, c^{j}_{tw}, c^{j,1}ₕ, . . . , c^{j,Njh}ₕ, and ∀i,j∈Z, which satisfy a prescribed condition on the basis of the input data for model estimation and the building thermal model (step S13). After the estimation, the building thermal model estimation unit 104 inputs the estimated building thermal model parameters into the data storage unit 103.

Specifically, the building thermal model estimation unit 104 estimates the building thermal model parameter, for example, that minimizes the evaluation function on a difference between the indoor temperature of the input data for model estimation for the estimated period and the indoor temperature computed on the basis of the building thermal model and the input data for model estimation expressed by the equations (1) to (3). To estimate the building thermal model parameters c^{j}_{fw}, c^{i,j}ₛₐ, c^{i,j}_{z}, c^{j}ₒₐ, c^{j}ₛᵣ, c^{j}_{tw}, c^{j,1}ₕ, . . . , c^{j,Njh}ₕ, and ∀i,j∈Z satisfying the condition, the building thermal model estimation unit 104 solves the optimization problem by performing computations.

The evaluation function may be a square sum used in the least-square method or may be a function based on the Biweight function used in the robust estimation method. Furthermore, various functions other than the functions based on the square sum or on the Biweight function may be used as evaluation functions.

The building thermal model estimation unit 104 computes the building thermal model parameters c^{j}_{fw}, c^{i,j}ₛₐ, c^{i,j}_{z}, c^{j}ₒₐ, c^{j}ₛᵣ, c^{j}_{tw}, c^{j,1}ₕ, . . . , c^{j,Njh}ₕ, and ∀i,j∈Z satisfying the conditions by using a soluble algorithm for the evaluation functions to be used. For example, by using meta-heuristics represented by the evolutionary algorithm as a soluble algorithm, the building thermal model estimation unit 104 is able to derive a solution of the optimization problem even if any kind of evaluation function is used.

Subsequently, the data storage unit 103 stores the building thermal model parameters obtained as a result of computing the estimation (step S14). Specifically, the data storage unit 103 stores the building thermal model parameters c^{j}_{fw}, c^{i,j}ₛₐ, c^{i,j}_{z}, c^{j}ₒₐ, c^{j}ₛᵣ, c^{j}_{tw}, c^{j,1}ₕ, . . . , c^{j,Njh}ₕ, and ∀i,j∈Z computed by the building thermal model estimation unit 104. After storing the building thermal model parameters, the building thermal model generation apparatus 100 completes the computation process.

The following describes a specific example of an internal thermal load model depending on the type of a building to be processed.

### EXAMPLE 1

Consideration will be made on the internal thermal load model, for example, in the case where a building to be processed is an office building. The office building is mainly used as an office.

Specifically, since a predetermined business is exclusively performed every day in an office building, the daily changes in the behavior pattern of workers and the uses of electrical equipment in the office building tend to be small. Moreover, regarding the behavior patterns of workers and the uses of electrical equipment, characteristic time changes are often seen in the office opening time, the lunch break time, and the office closing time.

Specifically, office workers gather in the office until the opening time. The workers then activate a lot of electrical equipment such as computers and printers. In other words, the internal thermal load is highest at the opening time during the day.

When the opening time has passed, the characteristic time change gradually disappears in the internal thermal load. The internal thermal load converges to a prescribed value until the lunch break time. The internal thermal load sometimes gradually increases or decreases until the lunch break time.

During the lunch break, a large number of workers go out to eat lunch. Moreover, workers sometimes stop electrical equipment. In other words, during the lunch break time, the internal thermal load temporarily decreases due to the office workers going out for lunch break, the stop of electrical equipment, or the like.

After the lunch break, the workers return to the office. In addition, the workers activate the stopped electrical equipment again. In other words, the internal thermal load returns to the amount observed in the period of time before the lunch break time. After the lunch break time, the internal thermal load gradually decreases toward the office closing time. After the office closing time, the internal thermal load significantly decreases and converts to a prescribed value after the decrease.

The aforementioned internal thermal load in the office building is expressed by the following equations, for example, by using a mathematical model.

$$\begin{matrix} [ Math . 5 ] & \\ {f}^{j} ( t ; {c}_{h}^{j , 1} , . . . , {c}_{h}^{j , {N}_{h}^{j}} ) = {\sum }_{k = 1}^{{N}_{triangle}^{j}} {f}_{triangle} ( t ; {c}_{h}^{j , 3 k - 2} , {c}_{h}^{j , 3 k - 1} , {c}_{h}^{j , 3 k} ) + {\sum }_{k = 1}^{{N}_{trapezoid}^{j}} {f}_{trapezoid} ( t ; {c}_{h}^{j , 4 k - 3 + 3 {N}_{triangle}^{j}} , {c}_{h}^{j , 4 k - 2 + 3 {N}_{triangle}^{j}} , {c}_{h}^{j , 4 k - 1 + 3 {N}_{triangle}^{j}} , {c}_{h}^{j , 4 k + 3 {N}_{triangle}^{j}} ) + {c}_{h}^{j , 3 {N}_{triangle}^{j} + 4 {N}_{trapezoid}^{j} + 1} , \\ ( 0 \leq t \leq T ) , ∀ j ∈ Z & Equation ( 4 )\end{matrix}$$

[Math. 6]

f^{j}(t+T)=f^{j}(t), (0≤t≤T), ∀j ∈Z Equation (5)

Incidentally, f_{triangle} in the equation (4) denotes a triangular pulse function. As showed in the equation (4), f_{triangle} has three coefficients. Further, f_{trapezoid} in the equation (4) denotes a trapezoidal pulse function. As showed in the equation (4), f_{trapezoid} has four coefficients. As showed in the equation (4), the function f^{j} is expressed by the sum of N^{j}_{triangle} number of triangular pulse functions, N^{j}_{trapezoid} number of trapezoidal pulse functions, and constants.

Furthermore, T in the equations (4) and (5) denotes the time of day. As showed in the equation (5), the function f^{j} in this example is expressed by a periodic function of a period T.

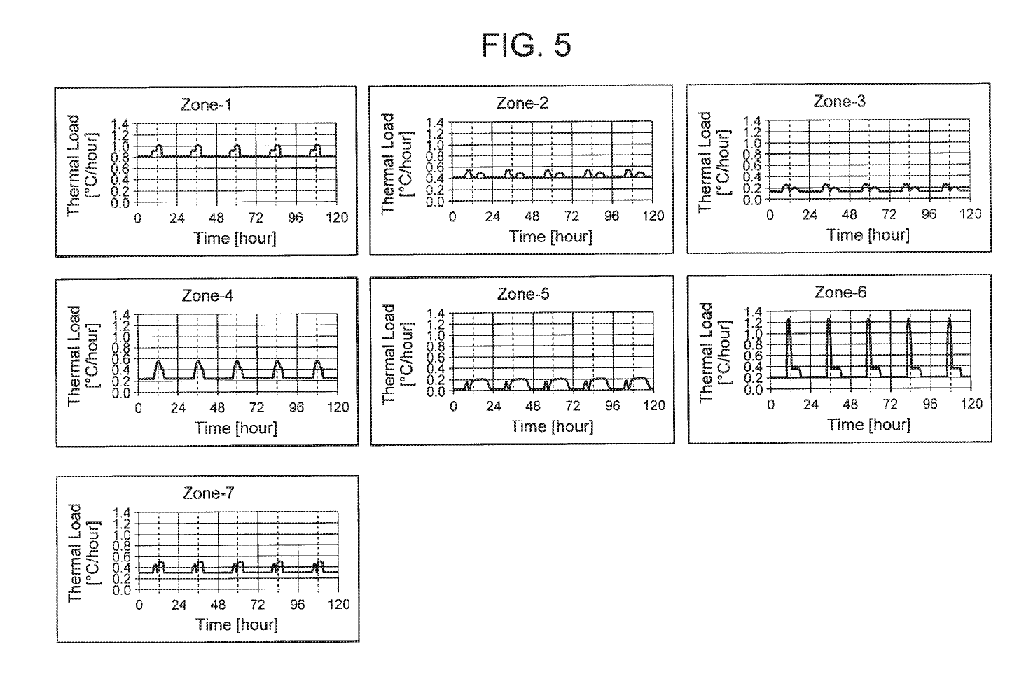

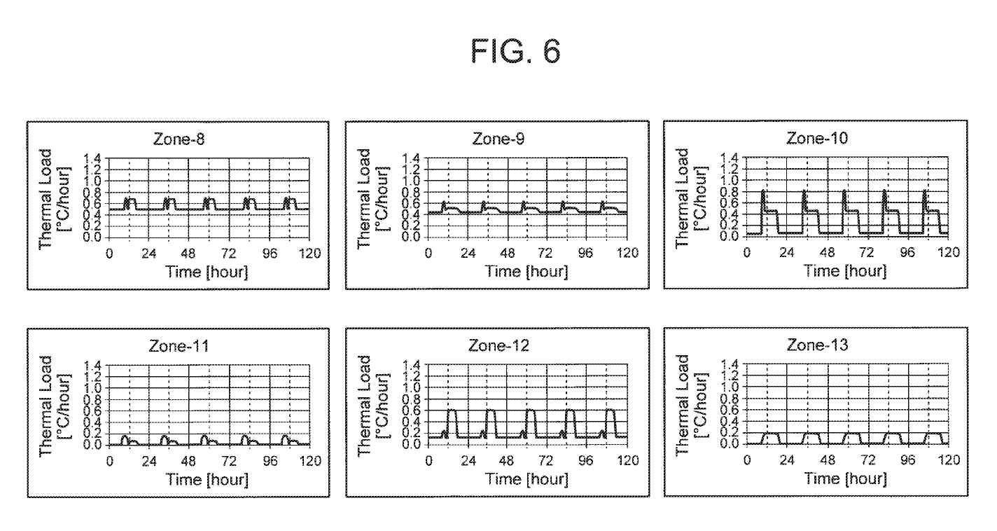

FIGS. 5 and 6 show examples obtained as a result of estimating the building thermal model by using the internal thermal load model expressed by the equations (4) and (5). FIG. 5 is an explanatory diagram showing examples of an estimation result of the time change of an indoor temperature change caused by internal thermal loads. Moreover, FIG. 6 is an explanatory diagram showing other examples of an estimation result of the time change of an indoor temperature change caused by internal thermal loads.

The estimation results showed in FIGS. 5 and 6 are those obtained by the building thermal model estimation unit 104 in such a way as to estimate the building thermal model with the number of zones n(Z) as 13 (n(Z)=13), the number of triangular pulse functions N^{j}_{triangle} as 1 (N^{j}_{triangle}=1), and ∀j∈Z, and with the number of trapezoidal pulse functions N^{j}_{trapezoid} as 1 (N^{j}_{trapezoid}=1) and ∀j∈Z. In other words, the estimation results showed in FIGS. 5 and 6 are examples obtained as identification results of the internal thermal loads output from the building thermal model generation apparatus 100.

FIG. 5 shows seven graphs respectively corresponding to zones 1 to 7. Furthermore, FIG. 6 shows six graphs respectively corresponding to zones 8 to 13. The horizontal axis of each graph showed in FIGS. 5 and 6 represents time, while the vertical axis thereof represents an indoor temperature change caused by internal thermal loads. Each graph showed in FIGS. 5 and 6 represents time changes over five days of the indoor temperature change caused by internal thermal loads in each corresponding zone.

The building thermal model estimation unit 104 is able to obtain the amount of indoor temperature change caused by the internal thermal loads over five days in each zone showed in FIGS. 5 and 6 by computing the above parameters on the basis of the equations (4) and (5).

### EXAMPLE 2

Consideration will be made on the internal thermal load model, for example, in the case where the building to be processed is a restaurant or other eating place. The time-varying pattern of the internal thermal loads in a restaurant is correlated with a visitor appearance pattern. In the restaurant, generally many visitors come to eat in mealtime zones for breakfast, lunch, and dinner.

Specifically, visitors begin to increase gradually from around before the start of each mealtime zone. Furthermore, visitors increase rapidly just before the start of each mealtime zone. Moreover, visitors decrease rapidly after each mealtime zone, and then visitors gradually decrease as time proceeds.

The internal thermal load in the above restaurant is expressed by the following equation using, for example, a mathematical model.

$$\begin{matrix} [ Math . 7 ] & \\ {f}^{j} ( t ; {c}_{h}^{j , 1} , . . . , {c}_{h}^{j , {N}_{h}^{j}} ) = {\sum }_{k = 1}^{{N}_{gaussian}^{j}} {c}_{h}^{j , 3 k - 2} \times {f}_{gaussian} ( t ; {c}_{h}^{j , 3 k - 1} , {c}_{h}^{j , 3 k} ) + {c}_{h}^{j , 3 {N}_{gaussian}^{j} + 1} , \\ ( 0 \leq t \leq T ) , ∀ j ∈ Z & Equation ( 6 )\end{matrix}$$

[Math. 8]

f^{j}(t+T)=f^{j}(t),(0≤t≤T), ∀j ∈Z Equation (7)

Incidentally, f_{gaussian} in the equation (6) denotes a normal distribution function. As showed in the equation (6), f_{gaussian} has two coefficients. As showed in the equation (6), the function f^{j} is expressed by the sum of N^{j}_{gaussian} number of normal distribution functions and constants.

Furthermore, T in the equations (6) and (7) denotes the time of day. As showed in the equation (7), the function f^{j} in this example is expressed by a periodic function of period T.

Similarly to the case where the internal thermal load model is expressed by the equations (4) and (5), the building thermal model estimation unit 104 is able to estimate a building thermal model by using the internal thermal load model expressed by the equations (6) and (7). For example, the building thermal model estimation unit 104 is able to estimate the building thermal model by using the internal thermal load model expressed by the equations (6) and (7) with the number of normal distribution functions N^{j}_{gaussian} as 3 (N^{j}_{gaussian}=3) and ∀j∈Z.

In this example, the time change of the number of visitors is expressed by a superposition of normal distribution functions. Incidentally, the time change of the number of visitors may also be expressed by a superposition of functions suitable for a visitor appearance pattern in each store of the restaurant, instead of the normal distribution functions.

### EXAMPLE 3

Consideration will be made on the internal thermal load model, for example, in the case where the building to be processed is a retail store such as a department store, a supermarket, and a convenience store.

The number of visitors of a retail store is largely dependent on the meteorological condition, such as outside air temperature and weather. Therefore, to express the internal thermal load in a retail store with high accuracy, it is considered to use a function with the meteorological condition as a variable, as the function f^{j}, instead of a mere time function.

For example, as the function f^{j}, the building thermal model estimation unit 104 may use a function f^{j}(t, Tₒₐ, I; c^{j,1}ₕ, . . . c^{j,Njh}ₕ) with the outside air temperature Tₒₐ and the amount of solar radiation I as variables. In addition, the function f^{j} in this example may have the outside air relative humidity Hₒₐ, cloudiness C, precipitation P, and the like as variables.

Further, the form of the function f^{j} may be any form. For example, the form of the function f^{j} may be determined in advance on the basis of statistical methods such as a regression analysis using historical data of the number of visitors.

Similarly to the cases where the internal thermal load model is expressed by the equations (4) and (5) and expressed by the equations (6) and (7), the building thermal model estimation unit 104 is able to estimate the indoor temperature model and the internal thermal load model simultaneously. In other words, the building thermal model estimation unit 104 is able to obtain the building thermal model parameters.

[Description of Effects]

The building thermal model generation apparatus of this example embodiment implements the control with a model prediction for an air conditioning system at low cost and with high accuracy. This is because the building thermal model estimation unit 104 handles the building thermal model including an internal thermal load model.

Specifically, the building thermal model estimation unit 104 computes building thermal model parameters of a building thermal model composed of an indoor temperature model and an internal thermal load model by using meteorological data and air conditioner operating data.

The building thermal model estimation unit 104 computes the parameter of the indoor temperature model and the parameter of the internal thermal load model simultaneously. In other words, even if measuring devices are not added or experts do not perform any analysis, accurate estimated values of internal thermal loads (internal thermal load model) can be acquired at low cost.

Usually, a computation of an estimated value of the internal thermal load of a building requires an addition of measuring devices and analysis by experts and therefore is considerably costly. Furthermore, in the case where the estimated value includes an error, it is difficult to generate an operation plan for an air conditioning system having a high energy saving performance.

As described above, the building thermal model generation apparatus of this example embodiment is able to effectively handle the internal thermal loads of the building without the addition of measuring devices and analysis by experts. Specifically, the building thermal model generation apparatus is able to implement the control with a model prediction for an air conditioning system in consideration of internal thermal loads in a building at low cost and with high accuracy. With the use of the building thermal model generation apparatus of this example embodiment, an air conditioning operation with high energy efficiency is implemented in each building.

Incidentally, the building thermal model generation apparatus 100 of this example embodiment is implemented by, for example, hardware. Moreover, the building thermal model generation apparatus 100 of this example embodiment may also be implemented by, for example, a central processing unit (CPU) that performs processes in accordance with a program stored in a storage medium. In other words, the meteorological data acquisition unit 101, the air conditioner operating data acquisition unit 102, the data storage unit 103, and the building thermal model estimation unit 104 are implemented by, for example, the CPU that performs the processes in accordance with a program control.

In the above example, the program is stored in, for example, various types of non-transitory computer readable media and then supplied to the computer. The non-transitory computer readable media include various types of tangible storage media.

The non-transitory computer readable medium is, for example, a magnetic recording medium such as a flexible disk, a magnetic tape, and a hard disk drive, or a magneto-optical recording medium such as a magneto-optical disk. Furthermore, the non-transitory computer readable medium is an optical disk such as, for example, a compact disc read only memory (CD-ROM), CD-R, CD-R/W, digital versatile disc (DVD), or Blu-Ray® disc (BD).

Furthermore, the non-transitory computer readable medium is a semiconductor memory such, for example, a mask ROM, a programmable ROM (PROM), an erasable PROM (EPROM), a flash ROM, a random access memory (RAM), or the like.

Moreover, the program may be recorded on various types of transitory computer readable media and then supplied to computers. The transitory computer readable medium is, for example, an electrical signal, an optical signal, or an electromagnetic wave. The program recorded on the transitory computer readable medium is supplied to a computer via a wired communication path, such as an electrical wire or optical fibers, or via a wireless communication path.

Furthermore, each unit of the building thermal model generation apparatus 100 of this example embodiment may be implemented by a hardware circuit. As an example, each of the meteorological data acquisition unit 101, the air conditioner operating data acquisition unit 102, the data storage unit 103, and the building thermal model estimation unit 104 are implemented by a large scale integration (LSI) circuit. Further, they may be implemented by a single LSI circuit.

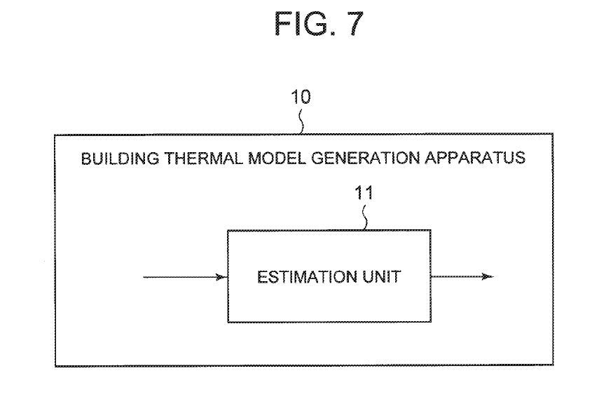

Subsequently, the outline of the present invention will be described. FIG. 7 is a block diagram showing the outline of the building thermal model generation apparatus according to the present invention. The building thermal model generation apparatus 10 according to the present invention includes an estimation unit 11 (for example, the building thermal model estimation unit 104) that estimates, by using data for estimation, a building thermal model parameter which satisfies a prescribed condition of a building thermal model indicative of the temperature of a building, the building thermal model including an internal thermal load model indicative of a time change of heat generated inside the building.

With the above configuration, the building thermal model generation apparatus is able to implement the control with a model prediction for an air conditioning system in consideration of internal thermal loads in a building at low cost and with high accuracy.

Moreover, the building thermal model for the building may include an indoor temperature model indicative of the temperature inside the building, and the building thermal model parameter may include a parameter of the indoor temperature model and a parameter of the internal thermal load model.

With the above configuration, the building thermal model generation apparatus may estimate the parameter of the indoor temperature model and the parameter of the internal thermal load model simultaneously.

Furthermore, the indoor temperature model may be a model represented by a mathematical model based on a heat conduction equation.

With the above configuration, the building thermal model generation apparatus is able to handle the indoor temperature model mathematically.

Furthermore, the building thermal model generation apparatus 10 may include a transmission unit that transmits a building thermal model parameter relating to the building estimated by the estimation unit 11 to the air conditioning control system that controls the air conditioner installed inside the building.

With the above configuration, the building thermal model generation apparatus is able to control the air conditioning control system by using the estimated building thermal model parameter.

Furthermore, the internal thermal load model may be a model represented by a time function indicative of a time change of heat generated inside the building.

With the above configuration, the building thermal model generation apparatus is able to handle the internal thermal load model mathematically.

Furthermore, the explanatory variables of the internal thermal load model may include environmental information. In addition, the environmental information may be information indicating the weather conditions.

With the above configuration, the building thermal model generation apparatus is able to handle the internal thermal load that depends on the environmental condition.

Moreover, the building thermal model generation apparatus 10 may include a meteorological data acquisition unit (for example, the meteorological data acquisition unit 101) that acquires data representing weather conditions and an air conditioner operating data acquisition unit (for example, the air conditioner operating data acquisition unit 102) that acquires data representing the operation conditions of the air conditioner.

Moreover, the building thermal model generation device 10 may include a data storage unit (for example, the data storage unit 103) for storing data acquired by the meteorological data acquisition unit and data acquired by the air conditioner operating data acquisition unit.

Furthermore, after retaining the building thermal model of a building and acquiring prescribed data for estimation from the data storage unit, the estimation unit 11 may obtain a thermal characterization parameter equivalent to an invariable physical property value for an estimated period and the internal thermal load for the estimated period on the basis of the retained building thermal model.

With the above configuration, the building thermal model generation apparatus is able to estimate the thermal characterization parameter and the internal thermal load simultaneously.

The present invention is not limited only to the above example embodiments, and it is needless to say that various modifications may be made without departing from the scope of the present invention described above.

Although the present invention has been described with reference to the example embodiments and examples, the present invention is not limited to the above example embodiments and examples. Various modifications, which can be understood by those skilled in the art, may be made in the configuration and details of the present invention within the scope thereof.

This application claims priority to Japanese Patent Application No. 2016-118512 filed on Jun. 15, 2016, and the entire disclosure thereof is hereby incorporated herein by reference.

### REFERENCE SIGNS LIST

10, 100 Building thermal model generation apparatus

11 Estimation unit

101 Meteorological data acquisition unit

102 Air conditioner operating data acquisition unit

103 Data storage unit

104 Building thermal model estimation unit

200 Air conditioning system operation planning device

201 Operation planning unit

202 Data storage unit

203 Air conditioner model acquisition unit

204 Air conditioner operating data acquisition unit

205 Meteorological data acquisition unit

206 Operation plan data output unit

What is claimed is:

1. A building thermal model generation apparatus comprising
an estimation unit which estimates, by using data for estimation, a building thermal model parameter which satisfies a prescribed condition of a building thermal model indicative of the temperature of a building, the building thermal model including an internal thermal load model indicative of a time change of heat generated inside the building.

2. The building thermal model generation apparatus according to claim 1, wherein:
the building thermal model for the building includes an indoor temperature model indicative of the temperature inside the building; and
the building thermal model parameter includes a parameter of the indoor temperature model and a parameter of the internal thermal load model.

3. The building thermal model generation apparatus according to claim 2, wherein the indoor temperature model is represented by a mathematical model based on a heat conduction equation.

4. The building thermal model generation apparatus according to claim 1, further comprising
a transmission unit which transmits the building thermal model parameter relating to the building estimated by the estimation unit to an air conditioning control system that controls an air conditioner installed inside the building.

5. The building thermal model generation apparatus according to claim 1, wherein the internal thermal load model is represented by a time function indicative of a time change of heat generated inside the building.

6. The building thermal model generation apparatus according to claim 1, wherein explanatory variables of the internal thermal load model include environmental information.

7. A building thermal model generation method comprising
a step of estimating, by using data for estimation, a building thermal model parameter which satisfies a prescribed condition of a building thermal model indicative of the temperature of a building, the building thermal model including an internal thermal load model indicative of a time change of heat generated inside the building.

8. The building thermal model generation method according to claim 7, wherein:
the building thermal model for the building includes an indoor temperature model indicative of the temperature inside the building; and
the building thermal model parameter includes a parameter of the indoor temperature model and a parameter of the internal thermal load model.

9. A non-transitory computer-readable recording medium having recorded therein a building thermal model generation program for causing a computer to perform
an estimation process of estimating, by using data for estimation, a building thermal model parameter which satisfies a prescribed condition of a building thermal model indicative of the temperature of a building, the building thermal model including an internal thermal load model indicative of a time change of heat generated inside the building.

10. The medium according to claim 9, wherein:
the building thermal model for the building includes an indoor temperature model indicative of the temperature inside the building; and
the building thermal model parameter includes a parameter of the indoor temperature model and a parameter of the internal thermal load model.

11. The building thermal model generation apparatus according to claim 2, further comprising
a transmission unit which transmits the building thermal model parameter relating to the building estimated by the estimation unit to an air conditioning control system that controls an air conditioner installed inside the building.

12. The building thermal model generation apparatus according to claim 3, further comprising
a transmission unit which transmits the building thermal model parameter relating to the building estimated by the estimation unit to an air conditioning control system that controls an air conditioner installed inside the building.

13. The building thermal model generation apparatus according to claim 2, wherein the internal thermal load model is represented by a time function indicative of a time change of heat generated inside the building.

14. The building thermal model generation apparatus according to claim 3, wherein the internal thermal load model is represented by a time function indicative of a time change of heat generated inside the building.

15. The building thermal model generation apparatus according to claim 4, wherein the internal thermal load model is represented by a time function indicative of a time change of heat generated inside the building.

16. The building thermal model generation apparatus according to claim 11, wherein the internal thermal load model is represented by a time function indicative of a time change of heat generated inside the building.

17. The building thermal model generation apparatus according to claim 12, wherein the internal thermal load model is represented by a time function indicative of a time change of heat generated inside the building.

18. The building thermal model generation apparatus according to claim 2, wherein explanatory variables of the internal thermal load model include environmental information.

19. The building thermal model generation apparatus according to claim 3, wherein explanatory variables of the internal thermal load model include environmental information.

20. The building thermal model generation apparatus according to claim 4, wherein explanatory variables of the internal thermal load model include environmental information.
